(19) United States
(12) Patent Application Publication
(10) Pub. No.: US 2008/0030351 A1
(43) Pub. Date: Feb. 7, 2008

(54) Alarm device of barbeque

(76) Inventor: William Home, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/890,499

(22) Filed: Aug. 7, 2007

(30) Foreign Application Priority Data
Aug. 7, 2006 (TW) 095213859

(51) Int. Cl. G08B 17/12

(52) U.S. Cl. 340/578

(57) ABSTRACT

An alarm device includes a thermocouple arranged in a barbeque to detect a flaming condition of the barbeque and to supply a corresponding analog detection signal, a signal amplifier comparator circuit receiving and amplifying and calibrating the analog detection signal from the thermocouple and supplying a corresponding digital signal, a fuel gas switch detection unit coupled to a fuel gas switch of the barbeque and supplying an ON/OFF signal of the fuel gas switch, a microprocessor connected to the digital signal from the signal amplifier comparator circuit and the ON/OFF signal of the fuel gas switch from the fuel gas switch detection unit so as to drive an alarm drive circuit at the time when the flame of the barbeque is extinguished due to causes rather than shut-off of the fuel gas switch, and in response thereto, the alarm drive circuit activating an alarm element, such as a buzzer or an indicator or both, to issue an alarm of sound or light or both, and a power supply device for powering the alarm device.

### BACKGROUND OF THE INVENTION

1. Field of the Invention

The present invention relates to an alarm device for a barbeque, and in particular to an alarm device that detects flaming condition and issues sound or light alarm to indicate extinguishment of flame of the barbeque.

2. The Related Arts

Barbeque is one of the widely used measures for processing foods, which can be easily carried out indoors/outdoors or in a yard. The currently available barbeques are comprised of burner consuming fuel gas or liquidized fuel to serve a heat source for cooking foods. Thus, monitoring the flaming condition of the burner is an important issue for barbequing. Surrounding conditions, such as blows, exhaustion of fuel, and part failure, often lead to extinguishment of flame of the burner. Further, undesired extinguishment of burner flame also causes leakage of fuel, which often induces risk of barbequing.

Anti-blow barbeques are available, which provides a barrier to protect the burner flaming against blows. However, the conventional barbeque cannot alarm against and indicate flaming extinguishment caused by exhaustion of fuel or parts failure.

U.S. Pat. No. 5,127,824 provides a barbeque burner of a well-known structure, but no monitoring for burner flaming is available. Thus, in the conventional burner, risk and dangers caused by undesired flaming extinguishment due to blows, exhaustion of fuel, and parts failure cannot be eliminated.

Therefore, it is desired to provide an alarm device for barbeques to alleviate the drawbacks of the conventional barbeques discussed above.

### SUMMARY OF THE INVENTION

An objective of the present invention is to provide an alarm device of a barbeque, which precisely issues an alarm of sound or light when the flame of the barbeque is unexpectedly extinguished in order to eliminate the risk of leakage of fuel gas that is intended to supply to the barbeque for food cooking.

Another objective of the present invention is to provide an alarm device comprises a thermocouple arranged in a barbeque and a fuel gas switch detection unit that is coupled to a switch or valve of a fuel gas supply, by which detection of extinguishment of barbeque flaming is more precise so that undesired extinguishment of flame that is not caused by shutting off the switch or valve can be correctly detected and false detection and error alarm can be eliminated.

To realize the objectives, in accordance with the present invention, an alarm device comprises at least one thermocouple, a signal amplifier comparator circuit, at least one fuel gas switch detection unit, a microprocessor, an alarm drive circuit, an alarm element, and a power supply device, wherein the thermocouple is arranged in a barbeque to detect a flaming condition of the barbeque and to supply a corresponding analog detection signal; the signal amplifier comparator circuit receives and amplifies and calibrates the analog detection signal from the thermocouple and supplies a corresponding digital signal; the fuel gas switch detection unit is coupled to a fuel gas switch or valve of the barbeque and supplies an ON/OFF signal of the fuel gas switch; the microprocessor is connected to the digital signal from the signal amplifier comparator circuit and the ON/OFF signal of the fuel gas switch from the fuel gas switch detection unit so as to drive the alarm drive circuit at the time when the flame of the barbeque is extinguished due to causes rather than shut-off of the fuel gas switch, and in response thereto, the alarm drive circuit activates the alarm element, which can be a buzzer or an indicator, to issue an alarm of sound or light; and the power supply device supplies power to the above components/devices, thereby realizing precise and exact detection of flaming of the barbeque and issuing of alarm indicating flaming extinguishment.

### BRIEF DESCRIPTION OF THE DRAWINGS

The present invention will be apparent to those skilled in the art by reading the following description of preferred embodiments thereof, with reference to the attached drawings, wherein:

FIG. 1 is a block diagram of an alarm device constructed in accordance with a first embodiment of the present invention;

FIG. 2 is a block diagram of a portion of an alarm device constructed in accordance with a second embodiment of the present invention, illustrating details of a signal amplifier comparator circuit of the alarm device;

FIG. 3 is a block diagram of an alarm device constructed in accordance with a third embodiment of the present invention;

FIG. 4 is a block diagram of an alarm device constructed in accordance with a fourth embodiment of the present invention;

FIG. 5 is schematic block diagram illustrating an application of the alarm device of FIG. 4; and

FIG. 6 shows a schematic diagram of a fifth embodiment of the present invention.

### DETAILED DESCRIPTION OF THE PREFERRED EMBODIMENTS OF THE PRESENT INVENTION

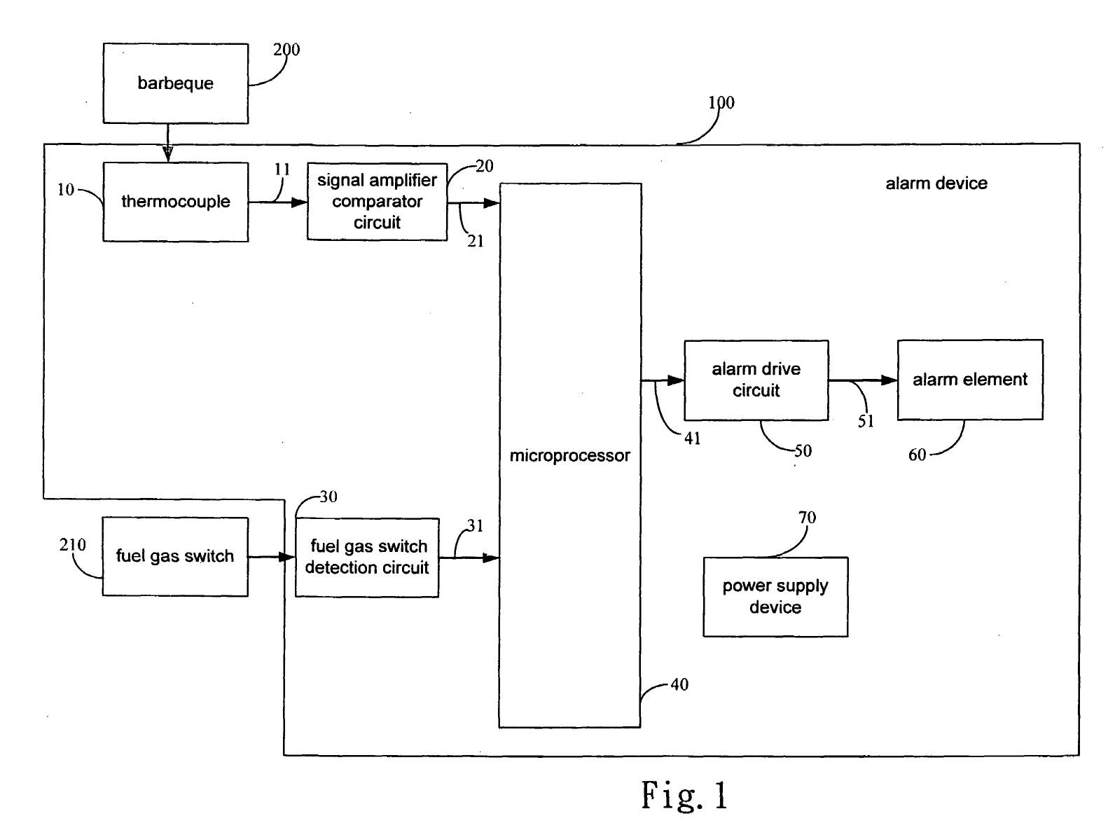

With reference to the drawings and in particular to FIG. 1, an alarm device of barbeque constructed in accordance with the present invention, generally designated with reference numeral 100, is shown. The alarm device 100 comprises at least one thermocouple 10, a signal amplifier comparator circuit 20, at least one fuel gas switch detection unit 30, a microprocessor 40, an alarm drive circuit, an alarm element 60, and a power supply device 70. The thermocouple 10 is arranged in a barbeque 200 to detect the flame condition of the barbeque 200 to which an analog detection signal 11 generated by the feature of the thermocouple 10 that converts thermal energy into electrical energy corresponds.

The signal amplifier comparator circuit 20 is connected to the thermocouple 10 to receive the analog detection signal 11. The signal amplifier comparator circuit 20 amplifies and compensates the analog detection signal 11 from the thermocouple 10 and in turn supplies a corresponding digital signal 21.

The fuel gas switch detection unit 30 is coupled to a fuel gas switch or valve 210 of the barbeque 200 to detect the ON/OFF state of the fuel gas switch 210 and, in response thereto, supplies a corresponding switch signal 31. The fuel gas switch detection unit 30 is not limited to any particular category, and a photo-electric sensing switch is taken as an example for illustration in this description. Other detectors or sensors, such as parallel switches and micro-switches, and equivalents thereof, can be used to take the position of the photo-electric sensing switch and serving as the fuel gas switch detection unit 30.

The microprocessor 40 is connected to both the signal amplifier comparator circuit 20 and the fuel gas switch detection circuit 30 to receive the digital signal 21 from the signal amplifier comparator circuit 20 and the switch signal 31 from the fuel gas switch detection circuit 30, whereby the microprocessor 40 makes decisions regarding alarms based on the digital signal 21 and the switch signal 31. For example, when the digital signal 21 indicates that the flame of the barbeque 200 is extinguished, and the switch signal 31 indicates a switch-on state, then the microprocessor 40 issues an alarm signal 41. Otherwise, no alarm signal is issued. For example, the digital signal 21 indicates that fire is extinguished, but the switch signal 31 indicates a switch-off state, then the microprocessor 40 issues no alarm signal. In other words, both the digital signal 21 and the switch signal 31 are used to determine alarms associated with various fire extinguished situations of the barbeque 200 when the fuel gas switch 210 is switched on, such as fire being extinguished by exhaustion of fuel gas, blows, or parts failure of the barbeque 200. Error alarms, such as barbeque 200 is not in a flaming condition while the fuel gas switch 210 is in an OFF state, can thus be excluded.

The alarm drive circuit 50 is connected to the microprocessor 4 to receive the alarm signal 41 from the microprocessor 40 and, in response thereto, generates an alarm drive signal 51.

The alarm element 60 is connected to the alarm drive circuit 50 for effecting alarming by being driven by the alarm drive signal 51. The alarm element 60 can be of any suitable configuration and category. In the embodiment illustrated, the alarm element 60 is embodied by a buzzer, which gives off sound alarm to indicate fire of the barbeque 200 being extinguished while the fuel gas switch 210 is set in an ON state.

The power supply device 70 supplies power to the signal amplifier comparator circuit 20, the at least one fuel gas switch detection unit 30, the microprocessor 40, the alarm drive circuit 50, ad the alarm element 60. The power supply device 70 is not limited to any particular category and a DC battery set is taken as an example in the present invention. However, power supply device of other types, such as AC/DC transformers or equivalents thereof, is also applicable in the present invention.

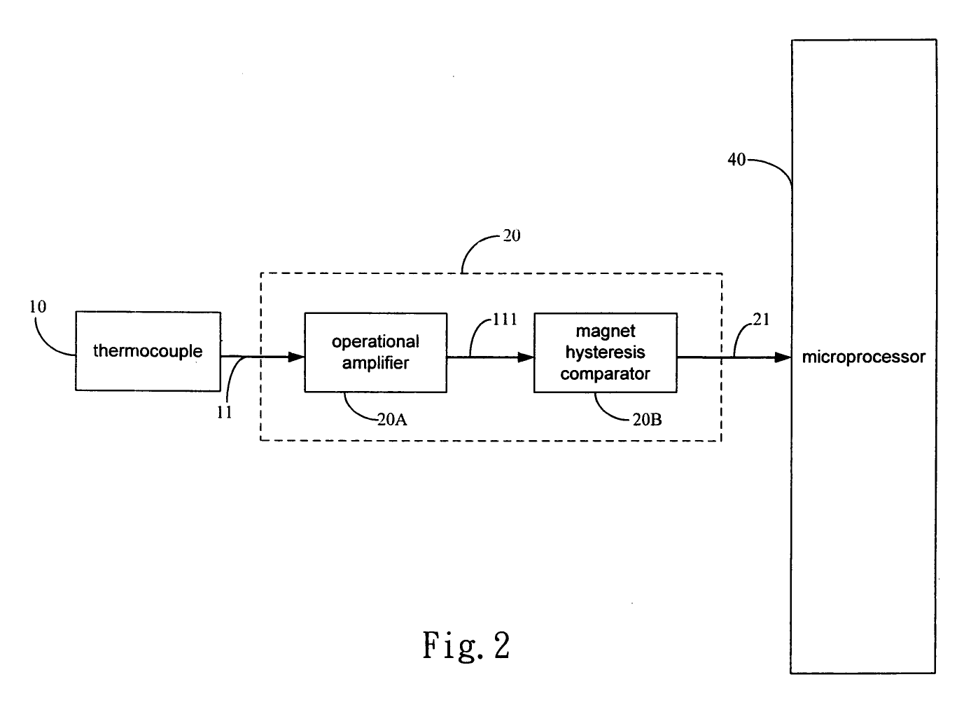

Also referring to FIG. 2, an alarm device constructed in accordance with a second embodiment of the present invention is shown, wherein the amplifier comparator circuit 20 is shown in more detail as compared to FIG. 1. The amplifier comparator circuit 20 comprises an operational amplifier 20A and a magnet hysteresis comparator 20B. The operational amplifier 20A is connected to the thermocouple 10 to receive and amplify the analog detection signal 11 from the thermocouple 10 so as to supply an amplified detection signal 111. The hysteresis comparator 20B is connected between the operational amplifier 20A and the microprocessor 40 to carry out voltage level comparison and calibration of hysteresis curve so as to obtain the digital signal 21 that is then applied to the microprocessor 40.

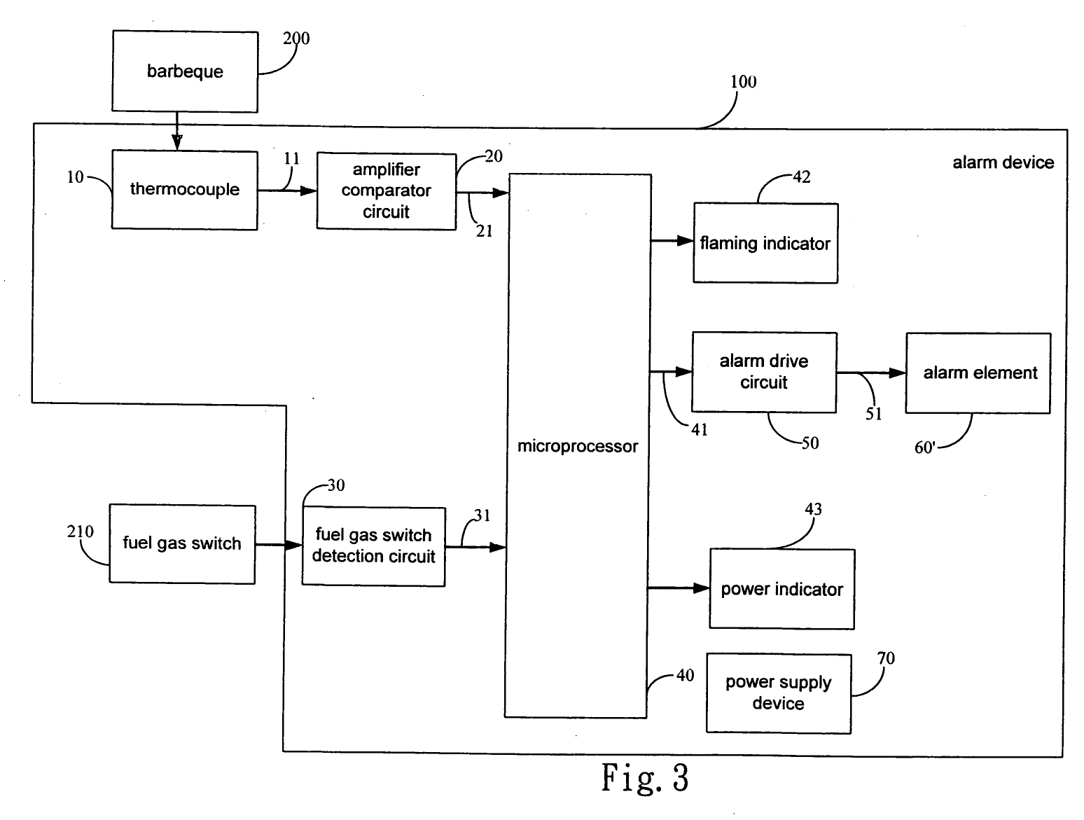

Also referring to FIG. 3, an alarm device constructed in accordance with a third embodiment of the present invention, also designated with reference numeral 100 for simplicity, is shown, wherein the microprocessor 40 is connected to a flaming indicator 42 and a power indicator 43. The flaming indicator 42 lights when the microprocessor 40 determines that the flame of the barbeque 200 is in a normal condition so as to indicate the normal operation of the barbeque 200. The power indicator 42 shows the power status of the power supply device 70. Further, the alarm element, which is designated with reference numeral 60′ in FIG. 3, is embodied as an indicator that gives off continuous lighting or flashes to indicate the flaming condition of the barbeque 200.

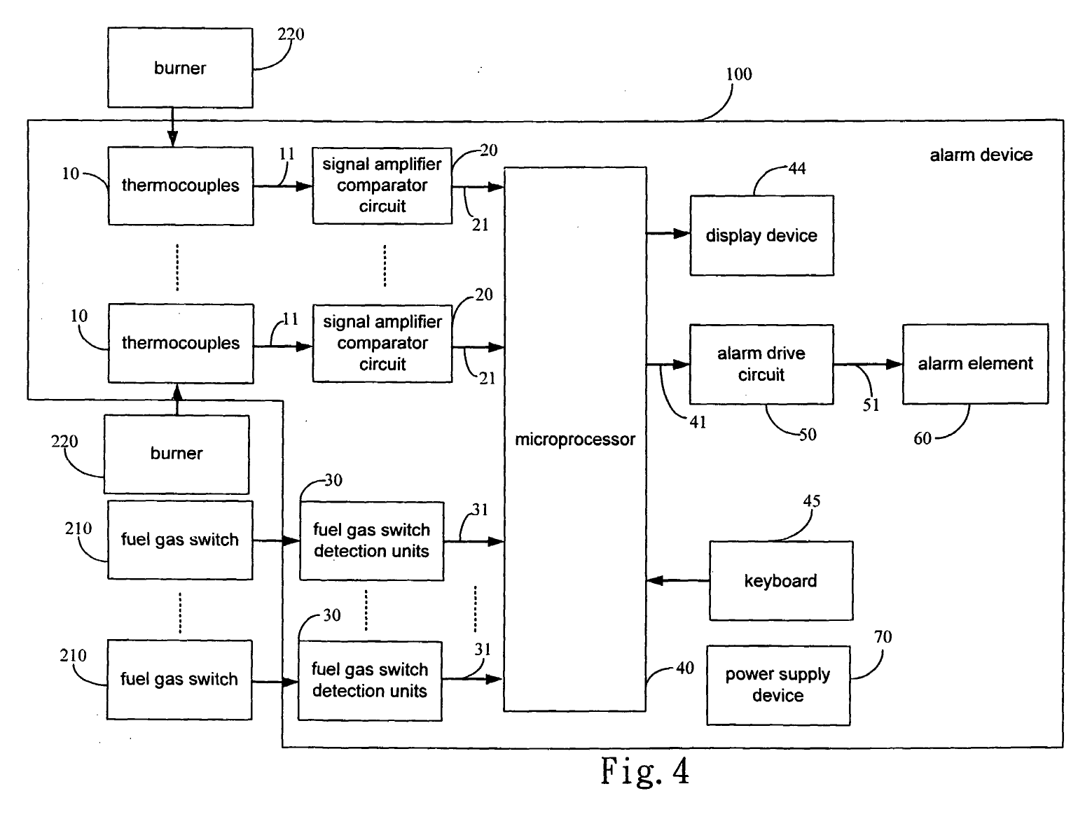

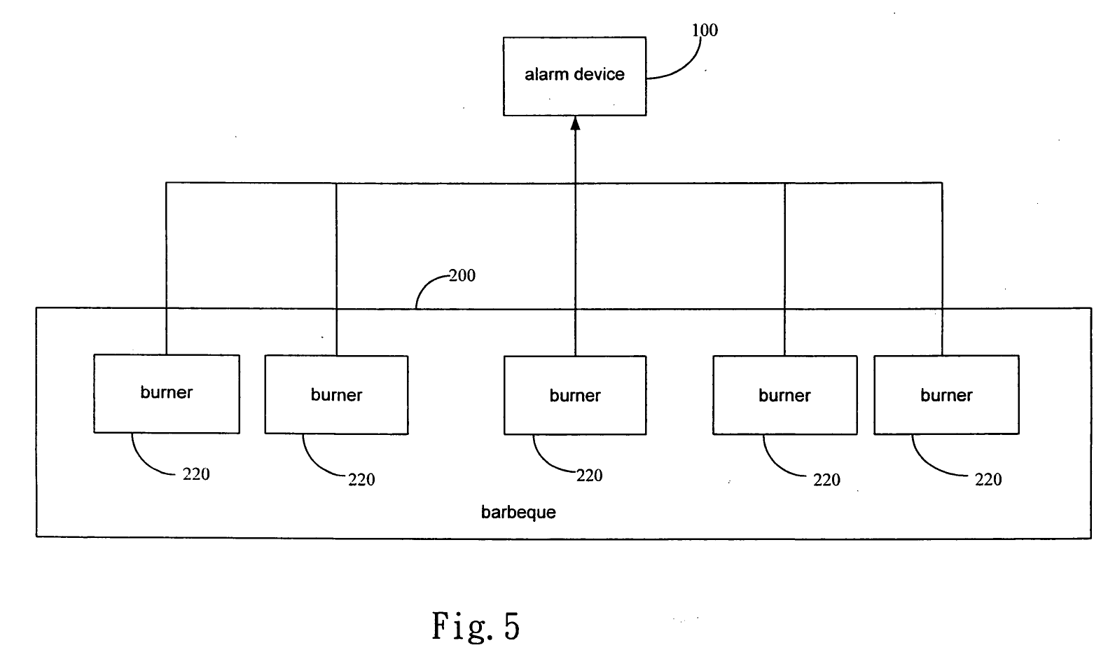

Referring now to FIGS. 4 and 5, an alarm device constructed in accordance with a fourth embodiment of the present invention, also designated with reference numeral 100, is shown. The alarm device of the fourth embodiment is applicable to a barbeque 200 having a number of burners 220, wherein a plurality of thermocouples 10 is connected to the respective burner 220 of the barbeque 200 to independently detect extinguishment of flame of each burner 220 and a plurality of signal amplifier comparator circuits 20 connected between respective thermocouples 10 and the microprocessor 40 to convert the analog detection signal 11 from each thermocouple 10 into a digital signal 20 applied to the microprocessor 40 for detection of the flaming condition of each burner 220. A plurality of fuel gas switch detection units 30 is connected between a fuel gas switch 210 of the respective burner 220 and the microprocessor 40 to independently detect the state of the fuel gas switch 210 of each burner 220 and to generate and apply switch signals 31 to the microprocessor 40 for determining if the state of the fuel gas switch 210 of each burner 220 is ON or OFF.

A display device 44 and a keyboard 45 are provided, and connected to the microprocessor 40. The display device 44 can be any suitable type of display, such as a liquid crystal display (LCD), which is taken as example in the description. However, other displays, such as light-emitting diode (LED) based display or a lamp signal based display, can also be used without departing from the scope of the present invention. The display device 44 serves to display the flaming condition and extinguishment alarm state of each burner 220. The keyboard 45 allows a user to enter operation instructions, such as setting alarm parameters, resetting, and switching of display.

As shown in FIG. 5, which shows an application of the alarm device shown in FIG. 4, the alarm device 100 of the present invention can be extended to detect flaming conditions of a plurality of burners 220 comprised of a barbeque 200 and issuing alarm through the alarm element 60 (60′) as a sound alarm or a lighting alarm. The alarm can be further displayed on the display device 44 so as to effectively and efficiently inform a user of the extinguished burner 220 and allow the user to immediately fix any possible failure condition that causes the extinguishment of flame for effecting alarm of flame extinguishment of any of a number of burners 220.

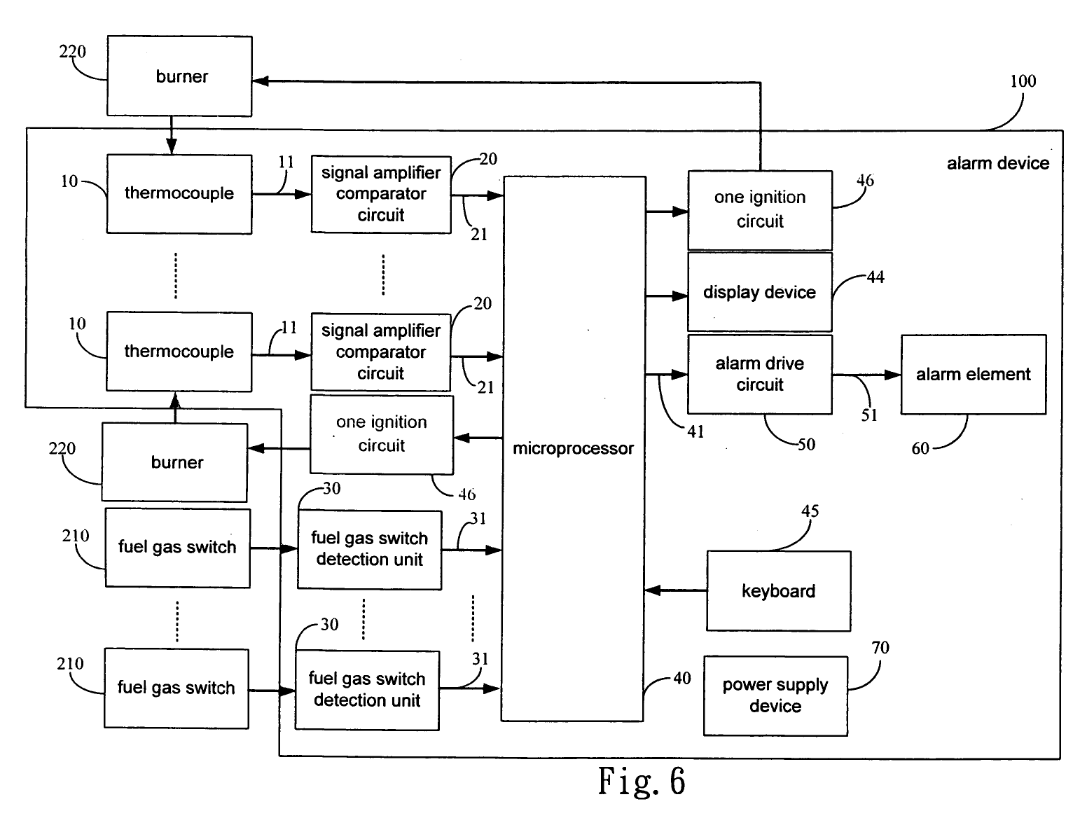

Also referring to FIG. 6, an alarm device constructed in accordance with a fifth embodiment of the present invention, also designated with reference numeral 100, is shown. The microprocessor 40 is connected to at least one ignition circuit 46, which corresponds to a respective burner 220 of the barbeque 200 for automatic ignition of the burner 220 when the burner 220 is undesired/accidentally extinguished. In other words, when the microprocessor 40 detects that the barbeque 200 is extinguished by means of the digital signal 21 from the signal amplifier comparator circuit 20 and at the same time, the fuel gas switch detection circuit 30 detects that the fuel gas switch 210 is in the ON state, a switched-on condition, besides effecting alarming through actuation of the alarm element 60 by the alarm drive circuit 50, the microprocessor 40 drives the ignition circuit 46 to re-light the fire of the barbeque 20, restoring the burners 220 of the barbeque 200 back into flaming condition, thereby automatically removing the fire extinguishment situation.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An alarm device of a barbeque, comprising:
at least one thermocouple arranged inside the barbeque to detect flaming condition of the barbeque and, in response thereto, supplying an analog detection signal;
a signal amplifier comparator circuit connected to the thermocouple to receive the analog detection signal and to amplify and process the analog detection to supply a digital signal;
at least one switch detection unit connected to a switch of the barbeque to detect ON/OFF state of the switch;
a microprocessor connected to the signal amplifier comparator circuit and the switch detection unit to receive the digital signal from the signal amplifier comparator circuit and the ON/OFF state of the switch for determining an flame extinguishment condition of the barbeque and supplying a corresponding alarm signal;
an alarm drive circuit connected to the microprocessor to receive the alarm signal and, in response thereto, supplying an alarm drive signal;
an alarm element connected to the alarm drive circuit to issue an alarm by being driven by the alarm drive signal; and
a power supply device that provides power to the signal amplifier comparator circuit, the at least one switch detection unit, the microprocessor, the alarm drive circuit, and the alarm element.

2. The alarm device as claimed in claim 1, wherein the thermocouple is set in a burner installed inside the barbeque.

3. The alarm device as claimed in claim 1, wherein the signal amplifier comparator comprises an operational amplifier connected to the thermocouple for amplifying the analog detection signal and a hysteresis comparator connected to the operational amplifier and the microprocessor for calibration of hysteresis curve.

4. The alarm device as claimed in claim 1 further comprising a keyboard connected to the microprocessor.

5. The alarm device as claimed in claim 1 further comprising a display device connected to the microprocessor.

6. The alarm device as claimed in claim 5, wherein the display device comprises a liquid crystal display.

7. The alarm device as claimed in claim 5, wherein the display device comprises a light-emitting diode based display.

8. The alarm device as claimed in claim 1, wherein the switch detection unit comprises a photo-electric sensing switch.

9. The alarm device as claimed in claim 1, wherein the alarm element comprises a buzzer.

10. The alarm device as claimed in claim 1, wherein the alarm element comprises an indicator.

11. The alarm device as claimed in claim 1, wherein the power supply device comprises a DC battery.

12. The alarm device as claimed in claim 1, wherein the microprocessor is connected to at least one ignition circuit.
